(19) United States
(12) Patent Application Publication
(10) Pub. No.: US 2025/0147463 A1
(43) Pub. Date: May 8, 2025

(54) PROCESSING CARTRIDGE

(71) Applicant: Zhuhai Ninestar Information Technology Co. , Ltd, Zhuhai (CN)

(72) Inventors: Qin DAI, Zhuhai (CN); Hailong MA, Zhuhai (CN); Yu CHEN, Zhuhai (CN); Baosheng ZHONG, Zhuhai (CN); Qin LUO, Zhuhai (CN)

(21) Appl. No.: 19/013,526

(22) Filed: Jan. 8, 2025

Related U.S. Application Data
(63) Continuation of application No. PCT/CN2023/113362, filed on Aug. 16, 2023.

(30) Foreign Application Priority Data
Aug. 19, 2022 (CN) 202222199710.4
Aug. 26, 2022 (CN) 202222271716.8
Aug. 31, 2022 (CN) 202222315065.8

(51) Int. Cl. G03G 21/18; G03G 21/16

(52) U.S. Cl. CPC G03G 21/1864; G03G 21/1647; G03G 21/1807; G03G 21/1814; G03G 21/1828

(57) ABSTRACT

A processing cartridge includes a photosensitive unit including a photosensitive component; a developing unit including a developing component, where the developing unit can move between a contact position where the developing component contacts the photosensitive component and a separated position where the developing component is separated from the photosensitive component relative to the photosensitive unit; a drum coupling for receiving a rotational driving force and transmitting the rotational driving force to the photosensitive component; a developing coupling for receiving the rotational driving force and transmitting the rotational driving force to the developing component; a force-applying component, where the force-applying component can move between an extended position where the developing component is separated from the photosensitive component and a retracted position where the developing component is in contact with the photosensitive component; and an elastic member for moving the force-applying component from the retracted position to the extended position.

### CROSS-REFERENCE TO RELATED APPLICATIONS

This application is a continuation of International Application No. PCT/CN2023/113362, filed Aug. 16, 2023, which claims priority of Chinese Patent Application No. 202222199710.4 filed on Aug. 19, 2022, Chinese Patent Application No. 202222315065.8 filed on Aug. 31, 2022, and Chinese Patent Application No. 202222271716.8 filed on Aug. 26, 2022, the entire content of each of which is hereby incorporated by reference.

### FIELD OF THE DISCLOSURE

The present application relates to the field of image forming technology, and specifically to a processing cartridge.

### BACKGROUND

An image forming device can be a four-color full-color laser image forming device using an electrophotographic process, where a processing cartridge is detachably mounted into the main assembly of the image forming device to form a color image on a recording material. The processing cartridge includes a photosensitive unit and a developing unit, where the photosensitive unit includes a photosensitive component (e.g., a photosensitive drum) and a charging component, and the developing unit includes a developing component (e.g., a developing roller) and a stirring component. The photosensitive component, the charging component, the developing component, and the stirring component can be independently rotatably mounted in the cartridge housing.

Referring to FIGS. 1-3, four processing cartridges 100 (i.e., 100Y, 100M, 100C, 100K) are detachably mounted in the main assembly 170 of the image forming device, namely the first processing cartridge 100Y, the second processing cartridge 100M, the third processing cartridge 100C and the fourth processing cartridge 100K, which are disposed substantially horizontally. The rotational driving force is output from the driving output part of the main assembly 170 of the image forming device, and the main assembly 170 of the image forming device provides bias voltages (e.g., charging bias, developing bias, etc.) to the first to fourth processing cartridges 100 (100Y, 100M, 100C, 100K) respectively. The processing cartridges are mounted in the main assembly of the image forming device through a tray 171. Specifically, the tray 171 is configured to be able to move in a substantially horizontal direction when the main assembly 170 of the image forming device is installed on a horizontal surface, and the four processing cartridges are respectively mounted in each positioning part of the tray. When the tray 171 moves into the main assembly 170 of the image forming device, the plurality of processing cartridges 100 move into the main assembly of the image forming device together with the tray 171. When a processing cartridge needs to be replaced, the front door 15 is opened, and the plurality of processing cartridges can move together with the tray 171 to the outside of the main assembly 170 of the image forming device.

The main assembly 170 of the image forming device is provided with a cartridge pressing mechanism including a storage element pressing unit 190 acting on the non-driving side and a cartridge pressing unit 191 acting on the driving side. The main assembly 170 further includes an intermediate transfer unit 12.

On the non-driving side, by closing the front door 15 of the image forming device, the storage element pressing unit 190 and the cartridge pressing unit 191 of the processing cartridge are lowered in the direction of the arrow Z2. The storage element pressing unit 190 mainly includes a main assembly side electrical contact (not shown) that can contact with an electrical contact of a storage element (not shown) provided in the processing cartridge 100. The storage element and the main assembly side electrical contact can contact and separate from each other through a linkage mechanism (not shown) linked with the front door.

On the driving side, after the front door 15 is closed (e.g., closed in the direction of the arrow in FIG. 3), the drum drive coupling 180 and the developing drive coupling 185 on the main assembly side for transmitting the driving force to the processing cartridge protrude in the direction of arrow Y1 through a linkage mechanism (not shown). In addition, by opening the front door, the drum drive coupling 180 and the developing drive coupling 185 are retracted in the direction of arrow Y2. The purpose of this configuration is, on the one hand, to better connect the drum drive coupling 180 and the developing drive coupling 185 on the main assembly side with the drum coupling and the developing coupling of the processing cartridge, respectively, so as to receive the driving force. On the other hand, it prevents the insertion/removal of the tray 171 from being hindered.

On the driving side, the developing separation control unit 195 controls the separation and contact processes of the developing unit relative to the photosensitive component by engaging with a part of the developing unit. The developing separation control unit 195 is disposed below the main assembly 170 of the image forming device. Specifically, the developing separation control unit 195 is disposed below the developing coupling and the photosensitive coupling in the vertical direction (e.g., along the arrow Z2 direction). The developing separation control unit 195 includes a developing separation control unit 195R on the driving side and a developing separation control unit 195L on the non-driving side. The developing separation control unit 195 is configured to be movable in the W41 and W42 directions by a control mechanism (not shown). The directions W41 and W42 are substantially parallel to the alignment direction X of the processing cartridges mounted in the main assembly 170 of the image forming device.

To make the developing separation control unit 195 engage with a part of the developing unit and control the separation/contact processes of the developing unit, the developing separation control unit 195 and a part of the developing unit must overlap in the vertical direction (i.e., Z2 direction). Therefore, after a processing cartridge 100 is inserted along the X1 direction, a part of the processing cartridge developing unit needs to protrude in the vertical direction (i.e., Z2 direction). When the processing cartridge is transported, the protruding part of the developing unit is often easily damaged, resulting in damage to the force-bearing part, which may affect its extension from the processing cartridge, and then cause force generated among the various components in the assembly. This easily causes the positional relationship between the developing unit and the photosensitive unit in the contact and separation states to remain unstable, which is very likely to affect the development performance and development quality of the processing cartridge.

### SUMMARY

One aspect of the disclosure provides a processing cartridge, which includes a photosensitive unit including a photosensitive component; a developing unit including a developing component, where the developing unit is capable of moving between a contact position where the developing component contacts the photosensitive component and a separated position where the developing component is separated from the photosensitive component relative to the photosensitive unit; a drum coupling for receiving a rotational driving force and transmitting the rotational driving force to the photosensitive component; a developing coupling for receiving the rotational driving force and transmitting the rotational driving force to the developing component; a force-applying component, where the force-applying component is capable of moving between an extended position where the developing component is separated from the photosensitive component and a retracted position where the developing component is in contact with the photosensitive component; and an elastic member for moving the force-applying component from the retracted position to the extended position, where, when the developing coupling does not receive the rotational driving force, the force-applying component is in the extended position under an action of the elastic member to separate the developing component from the photosensitive component, and when the developing coupling receives the rotational driving force to rotate the developing component, the force-applying component moves from the extended position to the retracted position, and the developing component is in contact with the photosensitive component.

In some embodiments, the processing cartridge has a driving side and a non-driving side, and the drum coupling, the developing coupling and the force-applying component are located on the driving side of the processing cartridge.

In some embodiments, when the photosensitive unit is set to be stationary, the developing unit is capable of rotating relative to the photosensitive unit around a rotation center; and when viewed from the driving side of the processing cartridge, the force-applying component is located on the developing coupling or below the rotation center.

In some embodiments, when the developing coupling does not receive a driving force to rotate the developing component, the force-applying component is in the extended position under the action of the elastic member and abuts against the photosensitive component or abuts against the photosensitive unit to separate the developing component from the photosensitive component.

In some embodiments, when the developing coupling receives the driving force to rotate the developing component, the force-applying component moves from the extended position to the retracted position, an abutting force of the force-applying component disappears, and the developing component contacts the photosensitive component.

In some embodiments, the photosensitive unit and the developing unit are rotatably connected; when the developing unit is subjected to the rotational driving force, the developing unit is capable of rotating in a clockwise direction relative to the photosensitive unit to contact the developing component with the photosensitive component; and when the developing unit is not subjected to the rotational driving force, the developing unit rotates in a counterclockwise direction relative to the photosensitive unit, and the developing component and the photosensitive component are in a separated state.

Another aspect of the disclosure provides a processing cartridge, which includes a photosensitive unit, including a photosensitive drum and a photosensitive frame; a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum; a developing coupling, configured for receiving a rotational driving force and arranged on a driving side of the developing unit; and a force-applying component, rotatably arranged on the driving side of the developing unit, wherein the force-applying component is capable of applying a thrust force to or avoiding the photosensitive unit, where, when the developing coupling does not receive the rotational driving force, the force-applying component maintains the developing unit in the separated position by applying the thrust force to the photosensitive unit, so that the photosensitive drum is separated from the developing roller, and when the developing coupling receives the rotational driving force and rotates, the developing unit rotates from the separated position to the contact position due to an action of a self-weight or a torque of the rotational driving force, so that the photosensitive drum is in contact with the developing roller.

In some embodiments, the processing cartridge further includes an elastic member, wherein, when the developing coupling does not receive the rotational driving force, the force-applying member rotates clockwise under the action of the elastic member to apply the thrust force to the photosensitive unit to separate the photosensitive drum from the developing roller.

In some embodiments, a driving side cover is provided on a driving side of the photosensitive unit; and when the developing coupling does not receive the rotational driving force, the force-applying member applies the thrust force to the driving side cover of the photosensitive unit to maintain the developing unit in the separated position by a reaction force.

In some embodiments, the developing unit further includes a developing protective cover; the force-applying component is rotatably arranged on the developing protective cover; and the driving side cover covers an outside of the developing protective cover.

In some embodiments, when the developing coupling receives the rotational driving force to rotate, the force-applying component rotates counterclockwise to avoid the driving side cover of the photosensitive unit, and the developing frame rotates from the separated position to the contact position due to a self-weight or a torque of the rotational driving force.

In some embodiments, the force-applying component is located below the developing coupling when viewed from a driving side of the processing cartridge.

In some embodiments, the force-applying component includes a protruding end; and when the developing coupling does not receive the rotational driving force, one end of the force-applying component applies the thrust force to the photosensitive unit to maintain the developing unit in the separation position.

In some embodiments, the photosensitive unit and the developing unit are connected by a spring so that the developing unit rotates relative to the photosensitive unit within a certain range.

Another aspect of the disclosure provides a processing cartridge, which includes a photosensitive unit, including a photosensitive drum and a photosensitive frame; a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum; a developing coupling, configured for receiving a rotational driving force and arranged on the driving side of the developing unit; and an elastic component, connecting the photosensitive unit and the developing unit, where, when the developing coupling does not receive a rotational driving force, the developing unit returns from the contact position to the separated position under an action of the elastic component, so that the developing roller is separated from the photosensitive drum, and when the developing coupling receives the rotational driving force to rotate, the developing unit rotates from the separated position to the contact position, so that the developing roller is in contact with the photosensitive drum.

In some embodiments, the elastic component is arranged on one side of an axial direction of the processing cartridge, one end of the elastic component is connected to the photosensitive unit, and another end of the elastic component is connected to the developing unit.

In some embodiments, the photosensitive unit further includes a driving side cover, and the developing unit further includes a driving side developing bracket; and the developing coupling is arranged on the driving side developing bracket, and the driving side cover is arranged on an outside of the driving side developing bracket.

Another aspect of the disclosure provides a processing cartridge, which includes a photosensitive unit, including a photosensitive drum and a photosensitive frame; a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum; a drum coupling, configured for receiving a rotational driving force and transmitting the rotational driving force to the photosensitive drum; a developing coupling, for receiving the rotational driving force and transmitting the rotational driving force to the developing roller; and a clutch mechanism, arranged on the photosensitive unit or on the developing unit, where, before the developing coupling receives the rotational driving force, the clutch mechanism keeps the developing unit in the separation position, and the developing roller is separated from the photosensitive drum, and when the developing coupling receives the rotational driving force and rotates, a torque generated by a rotation of the developing coupling causes the developing unit to rotate clockwise, so that the developing unit rotates from the separated position to the contact position, and the developing roller contacts the photosensitive drum.

In some embodiments, the clutch mechanism includes a first retaining part, which is arranged on the developing unit to rotate with a rotation of the developing unit.

In some embodiments, a driving side of the photosensitive unit is provided with a driving side cover, and the drum coupling extends outward through the driving side cover; and a driving side of the developing unit is provided with a developing protective cover, the first retaining part is arranged on the developing protective cover, and a shape of the first retaining part is set to protrude from the developing protective cover to the driving side cover.

In some embodiments, the clutch mechanism further includes a second retaining part, which is arranged on the driving side cover; and one side of the first retaining part or the second retaining part is provided with an inclined surface.

### BRIEF DESCRIPTION OF THE DRAWINGS

FIG. 1 is a cross-sectional view of an image forming device of the existing technology;

FIGS. 2 and 3 are schematic structural diagrams of image forming devices in the existing technology;

FIG. 4 is a cross-sectional view of a processing cartridge according to Embodiment 1 of the present disclosure;

FIG. 5 is a schematic structural diagram of a processing cartridge according to Embodiment 1 of the present disclosure;

FIG. 6 is a schematic diagram of an exploded structure of the driving side of a processing cartridge according to Embodiment 1 of the present disclosure;

FIG. 7 is a schematic diagram of an exploded structure of a processing cartridge in another direction of the driving side according to Embodiment 1 of the present disclosure;

FIG. 8 is another schematic structural diagram of a processing cartridge according to Embodiment 1 of the present disclosure;

FIG. 9 is another cross-sectional view of a processing cartridge according to Embodiment 1 of the present disclosure;

FIG. 10 is an exploded view of a clutch mechanism according to Embodiment 1 of the present disclosure;

FIG. 11 is a schematic structural diagram of a clutch mechanism in a disengaged state according to Embodiment 1 of the present disclosure;

FIG. 12 is a schematic structural diagram of a clutch mechanism in a disengaged state in another direction according to Embodiment 1 of the present disclosure;

FIG. 13 is a schematic structural diagram of the clutch mechanism in a disengaged state in yet another direction according to Embodiment 1 of the present disclosure;

FIG. 14 is a cross-sectional view of a clutch mechanism in the disengaged state according to Embodiment 1 of the present disclosure;

FIG. 15 is a schematic structural diagram of a clutch mechanism in the developing state according to Embodiment 1 of the present disclosure;

FIG. 16 is a cross-sectional view of a clutch mechanism in the developing state according to Embodiment 1 of the present disclosure;

FIG. 17 is a schematic structural diagram of a processing cartridge in a free state/separated state according to Embodiment 1 of the present disclosure;

FIG. 18 is a cross-sectional view of a processing cartridge in a free state/separated state according to Embodiment 1 of the present disclosure;

FIG. 19 is a schematic structural diagram of a processing cartridge in the developing state according to Embodiment 1 of the present disclosure;

FIG. 20 is a cross-sectional view of a processing cartridge in the developing state according to Embodiment 1 of the present disclosure;

FIG. 21 is a schematic structural diagram of a processing cartridge according to Embodiment 2 of the present disclosure;

FIG. 22 is an exploded view of the structure of a processing cartridge of Embodiment 2 of the present disclosure;

FIG. 23 is a schematic diagram of the driving side of a processing cartridge according to Embodiment 2 of the present disclosure;

FIG. 24 is a schematic diagram of the driving side of a processing cartridge with the driving side cover and the developing protective cover omitted, according to Embodiment 2 of the present disclosure;

FIG. 25 is a schematic structural diagram of a developing coupling, a sleeve and a driving-side developing bracket according to Embodiment 2 of the present disclosure;

FIG. 26 is a schematic structural diagram of an axial shifting component according to Embodiment 2 of the present disclosure;

FIG. 27 is a schematic structural diagram of a developing coupling according to Embodiment 2 of the present disclosure;

FIG. 28 is a schematic structural diagram of a force-applying component according to Embodiment 2 of the present disclosure;

FIG. 29 is a schematic structural diagram of a processing cartridge according to Embodiment 3 of the present disclosure;

FIG. 30 is an exploded view of the structure of a processing cartridge according to Embodiment 3 of the present disclosure;

FIG. 31 is a schematic diagram of the driving side of a processing cartridge with the non-driving side cover omitted, according to Embodiment 3 of the present disclosure;

FIG. 32 is a schematic diagram of the driving side of a processing cartridge according to Embodiment 3 of the present disclosure;

FIG. 33 is a schematic structural diagram of the non-driving side developing support, rotating component, axial shifting component and reset component according to Embodiment 3 of the present disclosure.

FIG. 34 is a schematic structural diagram of a processing cartridge according to Embodiment 4 of the present disclosure;

FIG. 35 is an exploded schematic diagram of a processing cartridge according to Embodiment 4 of the present disclosure;

FIG. 36 is a schematic diagram of the driving side of a processing cartridge with the driving side cover omitted, according to Embodiment 4 of the present disclosure;

FIG. 37 is a schematic diagram of the drive side of a processing cartridge with the driving side cover and the developing protective cover omitted, according to Embodiment 4 of the present disclosure; and

FIG. 38 is a schematic structural diagram of the back direction of the driving side of a processing cartridge with the photosensitive frame omitted, according to Embodiment 4 of the present disclosure.

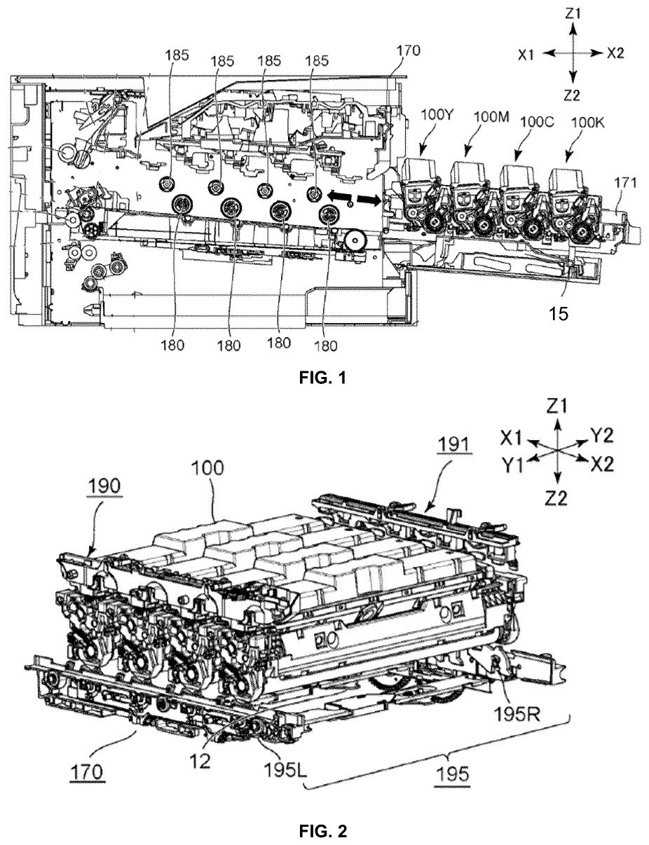

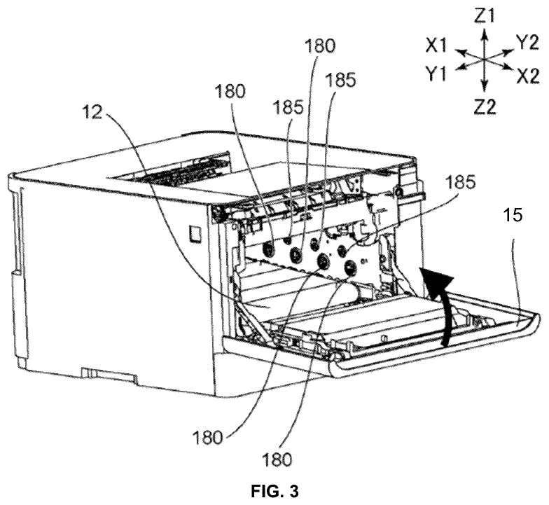

### DETAILED DESCRIPTION

The present disclosure is further described in detail hereinafter in conjunction with the accompanying drawings. Apparently, the described embodiments are merely part of the embodiments of the present disclosure, rather than all of the embodiments. Based on the embodiments of the present disclosure, all other embodiments obtained by a person skilled in the art without creative efforts fall within the protection scope of the present disclosure.

It should be noted that the terms “first”, “second”, etc., are merely used for descriptive purposes and cannot be understood as indicating or implying relative importance or implicitly indicating the number of the indicated technical features. Therefore, the features defined as “first” or “second” may explicitly or implicitly include at least one of the features. In the descriptions of the present disclosure, the meaning of “plurality” is at least two, such as two, three, etc., unless otherwise clearly and specifically defined.

In the present disclosure, unless otherwise clearly defined and limited, the terms “installation”, “connection”, “fixation” and the like should be understood in a broad sense. For example, a connection can be a fixed connection, a detachable connection, or an integral connection. A connection can be a mechanical connection. A connection can be a direct connection, or can be an indirect connection through an intermediate medium. A connection can be an internal connection of two elements or the interaction relationship between two elements, unless otherwise clearly defined. For a person skilled in the art, the specific meanings of the above terms in the present disclosure can be understood according to specific circumstances.

In the present disclosure, unless otherwise clearly specified and limited, a first feature being “above” or “below” a second feature may mean that the first and second features are in direct contact, or the first and second features are in indirect contact through an intermediate medium. Moreover, a first feature being “over”, “above” or “on top of” a second feature may mean that the first feature is directly above or obliquely above the second feature, or simply means that the first feature is higher in level than the second feature. A first feature being “below”, “under” or “underneath” a second feature may mean that the first feature is directly below or obliquely below the second feature, or simply means that the first feature is lower in level than the second feature.

Throughout the specification, the descriptions with reference to the terms “one embodiment”, “some embodiments”, “example”, “specific example”, “some examples”, etc., mean that the specific features, structures, materials or characteristics described in conjunction with the embodiments or examples are included in at least one embodiment or example of the present disclosure. In this specification, the schematic representations of the above terms do not necessarily refer to the same embodiment or example. Moreover, the specific features, structures, materials or characteristics described may be combined in one or more embodiments or examples in a suitable manner. In addition, those skilled in the art may combine and integrate the different embodiments or examples described in this specification and the features of the different embodiments or examples, without contradiction.

### Embodiment 1

The present disclosure provides a processing cartridge 100, which is detachably mounted in a main assembly of an image forming device.

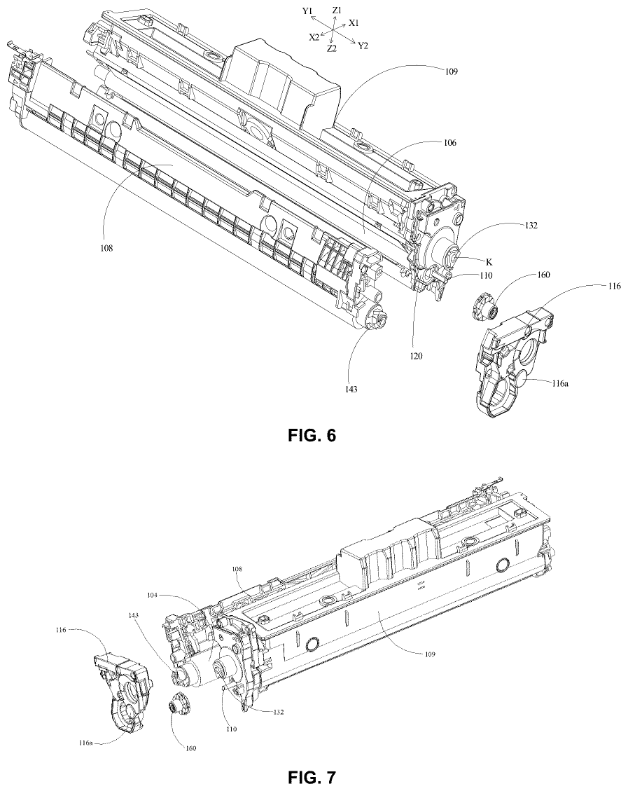

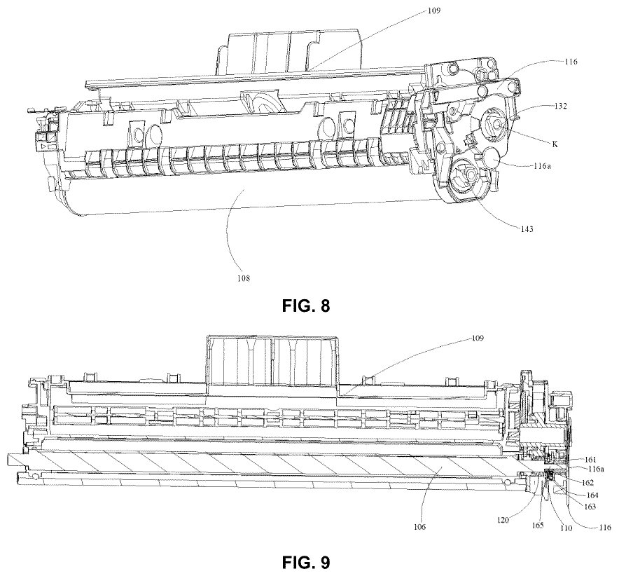

For ease of understanding, a three-dimensional rectangular coordinate system is established. Referring to FIG. 6, the length direction of the processing cartridge 100 on a horizontal plane is the first direction, the width direction of the processing cartridge 100 on the horizontal plane is the second direction, and the vertical direction is the third direction. The first direction, the second direction and the third direction are perpendicular to each other, and are respectively represented as Y, X, and Z directions in the present disclosure. The Y direction includes the Y2 direction close to the driving side of the processing cartridge 100, and the Y1 direction close to the non-driving side of the processing cartridge 100. The X direction includes the X1 direction toward the inside of the main assembly, and the X2 direction away from the main assembly. The Z direction includes the vertically upward Z1 direction and the vertically downward Z2 direction.

The main assembly includes a driving component for transmitting a driving force to a processing cartridge 100, where the driving component includes a drum drive coupling for driving the photosensitive component 104 and/or a developing drive coupling for driving the developing component 106.

The processing cartridge 100 includes a photosensitive unit 108, a developing unit 109, and a clutch mechanism.

The photosensitive unit 108 includes a driving side cover 116, a non-driving side cover 117 (shown in the figures related to Embodiment 2 and Embodiment 3), a photosensitive frame 11 (shown in the figures related to Embodiment 2 and Embodiment 3), a photosensitive component 104 and a charging component rotatably disposed on the photosensitive frame along a first direction respectively, and a drum coupling 143 for receiving the driving force of the drum drive coupling on the main assembly side and transmitting it to the photosensitive component 104. The photosensitive component 104 is specifically a photosensitive drum.

The developing unit 109 includes a developing frame 41 (shown in the figures related to Embodiment 2 and Embodiment 3), a developing component 106, a powder feeding roller and a stirring component rotatably disposed on the developing frame along a first direction, and a developing coupling 132 for receiving the driving force of the developing drive coupling on the main assembly side and transmitting the force to the developing component 106. The developing component 106 is specifically a developing roller.

The processing cartridge 100 has a driving side facing the Y2 direction. The drum coupling 143 and the developing coupling 132 are disposed on the driving side of the processing cartridge 100 to receive the driving force from the driving component of the main assembly. The driving side cover 116 is for covering the driving side of the photosensitive frame and the developing frame. The processing cartridge 100 has a non-driving side facing the Y1 direction, and the non-driving side is not configured to receive the driving force. The non-driving side cover 117 is for covering the non-driving side of the photosensitive frame and the developing frame.

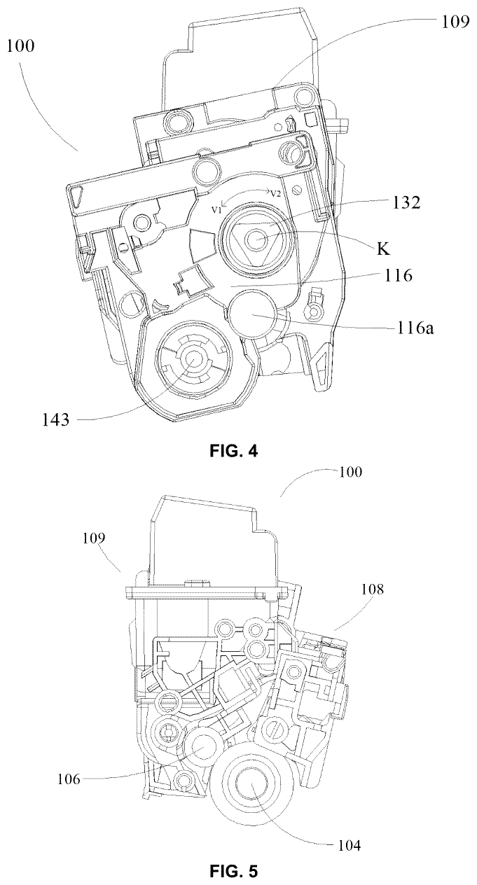

Referring to FIG. 4, the photosensitive unit 108 and the developing unit 109 are hinged by the rotation center K. In Embodiment 1, the photosensitive unit 108 is fixed, and the developing unit 109 can move freely around the rotation center K relative to the photosensitive unit 108. When the developing unit 109 is subjected to a force, the developing component 106 can rotate relative to the photosensitive component 104 along the V2 direction around the rotation center K and contact with the photosensitive component, that is, in a contact position. When the developing unit 109 is not subjected to a force, the developing component 106 can rotate relative to the photosensitive component 104 along the V1 direction around the rotation center K and separate from the photosensitive component 104, that is, in a separated position. In some embodiments, the developing unit 109 can also be fixed, and the photosensitive unit 108 can move freely around the rotation center K relative to the developing unit 109. When the photosensitive unit 108 is subjected to a force, the photosensitive component 104 can move relative to the developing component 106 and contact with the development component, that is, in a contact position. When the photosensitive unit 108 is not subjected to a force, the photosensitive component 104 is in a separated state relative to the developing component 106, that is, in a separated position.

In the embodiment disclosed herein, the developing unit 109 also includes a driving gear 120 and a connecting shaft 110. The driving gear 120 is fixedly connected to an end of the developing component 106 on the driving side. One end of the connecting shaft 110 is fixedly connected to the developing component 106. The driving gear 120 and connecting shaft 110 can be integrally developed or separately manufactured and fixed to each other. The other end of the connecting shaft 110 passes through the clutch mechanism 160 and abuts against the inner wall of the protrusion 116a of the driving side cover 116.

The general configuration of Embodiment 1 is as follows.

The clutch mechanism includes a force-applying component, and at least a portion of the clutch mechanism is rotatably disposed on the developing unit 109 with a first direction as the axial direction, so that the clutch mechanism is capable of rotating using the driving force output by the main assembly to the developing unit 109, and convert the rotational motion into an axial motion or radial motion. When the main assembly outputs the driving force to the developing unit 109, the force-applying component can generate a displacement in a direction perpendicular to the first direction, so that the developing unit 109 and the photosensitive unit 108 switch to the contact position (that is, the developing component 106 and the photosensitive component 104 switch to the contact position). When the main assembly stops outputting the driving force to the developing unit 109, the force-applying component can be reset (i.e., return to its original position) in a direction perpendicular to the first direction, so that the developing unit 109 and the photosensitive unit 108 switch to the separated position (that is, the developing component 106 and the photosensitive component 104 switch to the separated position). Furthermore, the clutch mechanism 160 also includes a reset component. When the main assembly stops outputting driving force to the developing unit 109, the reset component directly or indirectly drives the force-applying component to reset in a direction perpendicular to the first direction, and the force-applying component causes the developing unit 109 and the photosensitive unit 108 to switch to a separated position. The reset component can be an elastic component.

In the embodiment disclosed herein, the force-applying component is configured so that when the clutch mechanism receives the driving force output by the main assembly to the developing unit 109, the force-applying component can retract in the radial direction, withdraw the force applied to the photosensitive unit 108, which switches the developing unit 109 and the photosensitive unit 108 to the contact position. When the main assembly stops outputting the driving force to the developing unit 109, the force-applying component can extend in the radial direction, and apply a force to the photosensitive unit 108, which switches the developing unit 109 and the photosensitive unit 108 to the separated position.

The specific configuration of the embodiment disclosed herein is as follows.

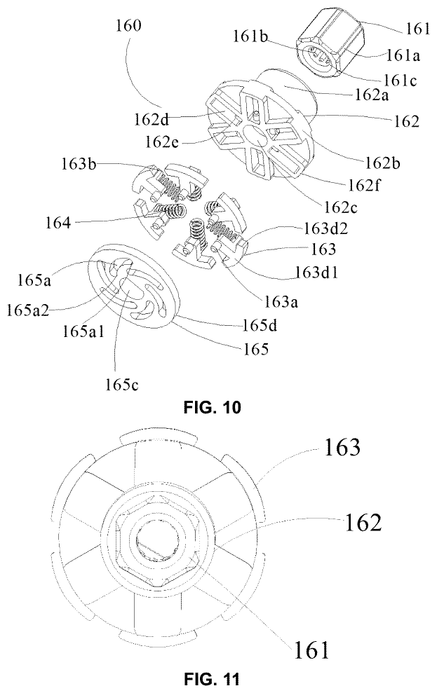

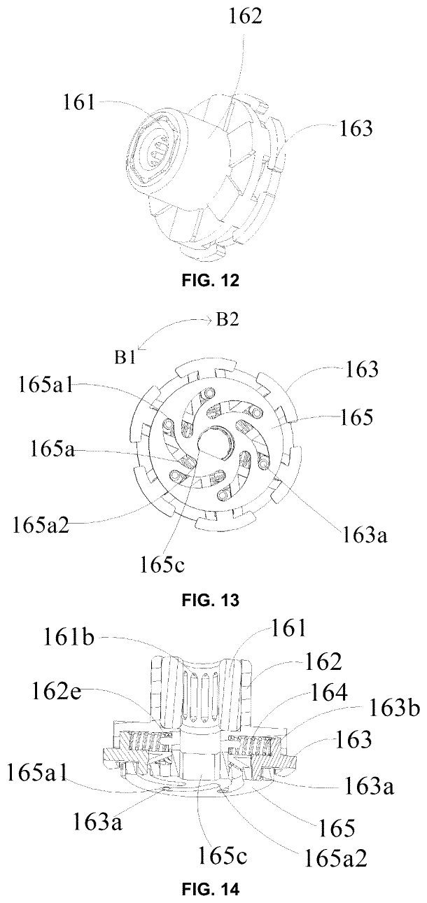

As shown in FIGS. 10 to 14, the clutch mechanism 160 in the embodiment disclosed herein is disposed on the driving side of the processing cartridge 100, and the clutch mechanism 160 includes a bearing 161, a supporting component 162, a force-applying component 163, a first elastic component 164 (the reset component is implemented as the first elastic component 164) and a rotary clamp 165. The bearing 161 has a through hole 161c engaged with the connecting shaft 110. The outer peripheral wall 161a of the bearing 161 is in a hexagonal shape, which is convenient for engaging with the supporting component 162. A bearing component 161b is disposed on the inner peripheral wall of the bearing 161.

The supporting component 162 has a through hole 162c for mounting the bearing 161, so that the connecting shaft 110 is rotatably connected to the supporting component 162 through the bearing 161. One end of the supporting component 162 is formed with a cylindrical shape 162a, and a disk 162b is connected to the cylindrical shape 162a. The disk 162b has protrusions disposed at intervals on the end surface of an end facing the cylindrical shape 162a. The number of protrusions is 6, and can also be 2, 4 or more than 6. The protrusions facing away from the cylindrical shape 162a are disposed on the end surface of the disk 162b. Grooves 162d are disposed at intervals on the end face of one end of the cylindrical shape 162a. The grooves 162d and the protrusions are correspondingly configured. The number of the grooves 162d is also 6, and can also be set to 2, 4, or more than 6. A protrusion 162e is disposed in the groove 162d near the through hole 162c. The protrusion 162e can protrude in the radial direction of the supporting component 162. The protrusion 162e can be integrally developed with the groove or fixedly connected after being manufactured separately. The groove 162d has an end face 162f which is parallel to the end face of the disk.

The force-applying components 163 are fan-shaped, with 6 of them disposed at intervals, corresponding to the grooves 162d on the supporting component 162, and disposed one by one in the grooves 162d. A boss 163b extending toward the supporting component 162 is provided on an end face 163d2 of the force-applying component 163 close to the supporting component 162, where the boss 163b can abut against the radial outer end of the groove 162d. A second guide part 163a extending relative to the boss 163b is provided on the other end face 163dl of the force-applying component 163 facing away from the supporting component 162. The second guide part 163a can specifically be a circular shaft, and the second guide part 163a is closer to the through hole 163c of the supporting component 162 than the boss 163b. There is a gap between the end face 162f of the groove on the supporting component 162 and the end face 163d2 on the force-applying component 163, so as to facilitate the extension and retraction of the force-applying component 163.

The first elastic component 164 has a large elasticity, one end of which abuts against the boss 163b on the force-applying component 163, and the other end is sleeved on the protrusion 162e in the groove 162d of the supporting component 162. When the supporting component 162, the force-applying component 163, and the first elastic component 164 are assembled, the first elastic component 164 is located in the groove 162d, and can be elastically deformed in the groove 162d as the force-applying component 163 extends and retracts.

The rotary clamp 165 is in the shape of a disk and has a through hole 165c fixedly engaged with the connecting shaft 110. A first guide part 165a is provided on the rotary clamp 165. The first guide part 165a can be a spiral arrangement, including at least one arc-shaped sliding chute or through hole disposed in a spiral manner. In the embodiment disclosed herein, there are six arc-shaped sliding chutes or through holes. A first guide part 165a is closed at both ends and has two end faces: a first end face 165a1 and a second end face 165a2. First end face 165a1 is closer to the radial outer side of the rotary clamp 165 relative to the second end face 165a2. The second guide part 163a on the force-applying component 163 is disposed in the first guide part 165a and slides therein. When the rotary clamp 165 and the force-applying component 163 are assembled together, a gap is set between one end face 165d of the rotary clamp and the other end face 163d1 on the force-applying component 163, which facilitates the extension and retraction of the force-applying component 163.

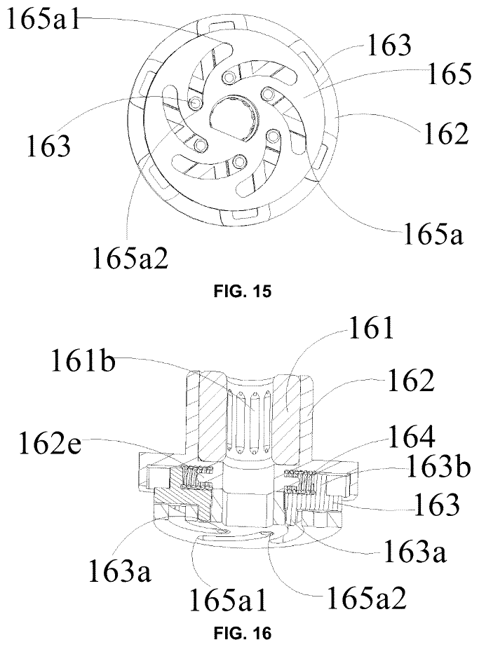

After the clutch mechanism 160 is assembled, it has two states. For an extended state (also called a separated state, corresponding to the separated position of the developing component and the photosensitive component), refer to FIGS. 13 and 14, where the force-applying component 163 extends radially to apply a force to the photosensitive unit. The second guide part 163a on the force-applying component 163 is located on the first end surface 165a1 side of the first guide part 165a, and the first elastic component 164 is in a free state in the groove 162d. For a retracted state (also called a developing state, corresponding to the contact between the developing component and the photosensitive component), refer to FIGS. 15 and 16, where the force-applying component 163 retracts radially to withdraw the force on the photosensitive unit, the second guide part 163a on the force-applying component 163 is located on the second end surface 165a2 side of the first guide part 165a, and the first elastic component 164 is compressed in the groove 162d. Here, when the force-applying component 163 extends or retracts in the radial direction, it is not limited to the force-applying component 163 strictly moving in the radial direction to extend or retract, but can also be moving in a direction inclined to the radial direction to extend or retract, as long as the force-applying component 163 is displaced in the radial direction (that is, the direction perpendicular to the first direction) (that is, as long as there is a partial displacement), so as to be able to apply or withdraw a force to the photosensitive unit.

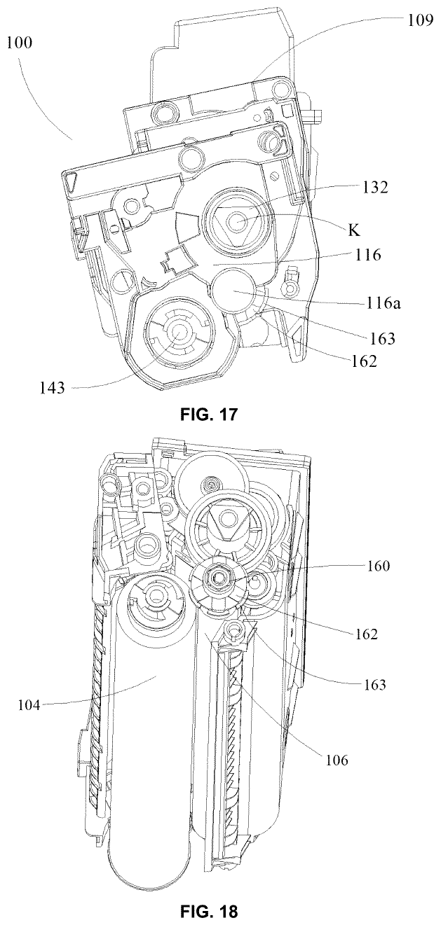

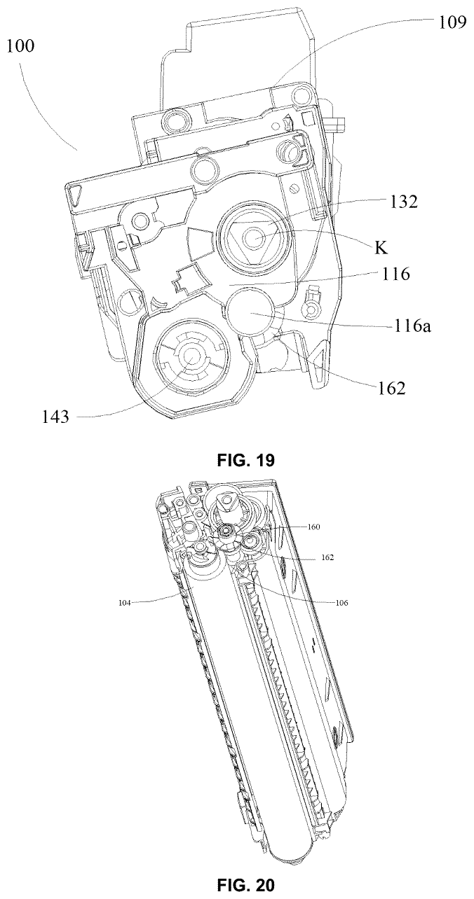

Referring to FIGS. 13 to 20, when the image forming device does not receive a work instruction, the developing component 106 is in a stationary state, and the connecting shaft 110 thereon does not rotate. At this moment, the clutch mechanism 160 is in an extended state, that is, under the action of the first elastic component 164, the force-applying component 163 extends and abuts against the photosensitive unit 108. Specifically, the force-applying component 163 may abut against the photosensitive component 104, or other parts of the photosensitive unit 108, so that the photosensitive unit 108 is subjected to a force, thereby separating the developing component 106 from the photosensitive component 104.

When the image forming device receives a working instruction, the main assembly outputs a driving force to the developing unit 109, and the developing component 106 receives the driving force through the driving gear 120 and the developing coupling 132 and starts to rotate. The connecting shaft 110 rotates accordingly. At this moment, the rotary clamp 165 fixedly connected to the connecting shaft 110 also rotates, and the force-applying component 163 moves from the extended state to the retracted state, that is, from the extended position to the retracted position. The developing component 106 contacts the photosensitive component 104 to achieve a developing process.

Further, referring to FIGS. 13 and 14, when the connecting shaft 110 rotates along the B2 direction, the rotary clamp 165 of the clutch mechanism 160 is first driven to rotate. Since other components of the clutch mechanism 160 are not restricted, these components temporarily do not rotate. When the rotary clamp 165 continues to rotate along the connecting shaft 110 in the B2 direction, the force-applying component 163 is pushed to move inward from the extended position to the retracted position, and the second guide part 163a thereon moves from the first end surface 165a1 toward the second end surface 165a2. At this moment, the first elastic component is compressed. Since the force-applying component 163 moves from the extended position to the retracted position, the force abutting against the photosensitive component 104 disappears, and the developing component 106 contacts the photosensitive component 104, and the developing process is performed. Refer to FIGS. 15 and 16, when the rotary clamp 165 continues to rotate in the B2 direction, the second guide part 163a on the force-applying component 163 is restricted by the second end surface 165a2 on the rotary clamp 165, and the force-applying component 163 rotates together with the rotary clamp 165. The force-applying component 163 drives the supporting component 162 to rotate, so that the entire clutch mechanism 160 rotates together with the connecting shaft 110, so that the clutch mechanism 160 will not hinder the rotation of the developing component 106, and the developing component 106 can work normally.

When the work on the image forming device is finished, the main assembly stops outputting the driving force to the developing unit, the developing component 106 stops rotating. The connecting shaft 110 thereon also stops rotating, and the clutch mechanism 160, except for the rotary clamp 165, will continue to rotate slightly in the direction of B2 under the inertial force. Since the first elastic component 164 is compressed at this time, the elastic force of the first elastic component 164 will be released instantly without any driving force. Under the action of the inertial force and the elastic force, the second guide part 163a on the force-applying component 163 will move from the second end face 165a2 of the first guide part 165a of the rotary clamp 165 toward the first end face 165a1, and the force-applying component 163 moves from the retracted position to the extended position. At this moment, the developing component 106 and the photosensitive component 104 are separated under the driving force of the force-applying component 163. In some embodiments, the first elastic component 164 may not be provided, and the second guide part is reset from the second end face to the first end face merely through the interaction between the first guide part and the second guide part and the inertial force.

When the image forming device receives a work instruction again, the above actions will be repeated.

The structure of the clutch mechanism 160 in the disclosed embodiment is not limited, and other structural forms can be adopted, as long as the above working state and working principle are achieved. For example, in some embodiments, the clutch mechanism 160 may not be coaxially disposed with the developing component 106, and may not be driven by the developing component 106, but may be axially disposed at other positions of the developing unit 109 with the first direction as the axial direction, as long as the clutch mechanism 160 can receive the driving force output by the main assembly to the developing unit. In some embodiments, the clutch mechanism 160 may also be axially disposed in a direction inclined to the first direction. The shape and structure of the first guide part and the second guide part may also be different. For example, the first guide part may be set as a protrusion, and the second guide part is a through hole or a sliding chute with both ends closed. The first guide part can move between the two ends of the second guide part, so that the force-applying component can extend or retract in the radial direction. The force-applying component 163 may also be other shapes instead of a fan shape, and the number of the force-apply components 163 may not be six, and these components may not be evenly distributed along the circumferential direction.

The present disclosure configures a clutch mechanism that uses the driving force output by the main assembly to the developing unit to move, and uses the rotational driving force output by the main assembly to move the clutch mechanism, so that the developing unit and the photosensitive unit can switch between the separated position and the contact position. This is achieved without using the developing separation control unit of the existing technology to achieve the position switching of the developing unit and the photosensitive unit, and without setting a protrusion that needs to protrude in the vertical direction (i.e., Z2 direction) relative to the developing unit to interact with the developing separation control unit, so as to prevent the protrusion from interfering with other structures and being damaged. Furthermore, by extending and retracting the force-applying component in the clutch mechanism that can generate displacement in the radial direction (i.e., the direction perpendicular to the first direction), a force is applied to or withdrawn from the photosensitive unit, so that the developing unit and the photosensitive unit can switch between the separated position and the contact position. This scheme is simple in principle and easy to implement.

### Embodiment 2

The main difference between Embodiment 2 and Embodiment 1 lies in that: when the clutch mechanism rotates using the driving force output by the main assembly to the developing unit, the clutch mechanism can convert the rotational motion into axial motion, instead of radial motion in Embodiment 1, through an axial shifting component.

The general configuration of Embodiment 2 is as follows.

The clutch mechanism of the embodiment disclosed herein further includes an axial shifting component, which is rotatably disposed on the developing unit 109 with the first direction as the axial direction, and is configured to convert a rotational motion into an axial motion. The axial shifting component is configured to be able to move axially when receiving the driving force output by the main assembly to the developing unit 109, so that the force-applying component moves, thereby switching the developing unit 109 and the photosensitive unit 108 to a contact position. When the main assembly stops outputting the driving force to the developing unit 109, the axial shifting component can be reset axially, so that the force-applying component moves again, thereby switching the developing unit 109 and the photosensitive unit 108 to a separated position.

Furthermore, the developing unit 109 also includes a first acting part, which is configured to be able to rotate using the driving force output by the main assembly to the developing unit 109. The axial shifting component is provided with a second acting part. The first acting part and the second acting part are structures that can be engaged with each other. When the axial shifting component is stationary and the main assembly outputs a driving force to the developing unit 109, the first acting part acts on the second acting part to drive the axial shifting component to retract in the axial direction toward the center of the processing cartridge 100. The force-applying component moves, and the force applied to the photosensitive unit 108 is withdrawn, so that the developing unit 109 and the photosensitive unit 108 switch to the contact position. The axial shifting component is then driven to rotate by the driving force output by the main assembly to the developing unit 109. When the main assembly stops outputting the driving force to the developing unit 109, the axial shifting component can be extended and reset in the axial direction away from the center of the processing cartridge 100. The force-applying component moves, thereby applying a force to the photosensitive unit 108, so that the developing unit 109 and the photosensitive unit 108 switch to the separated position.

The specific configuration of Embodiment 2 is as follows.

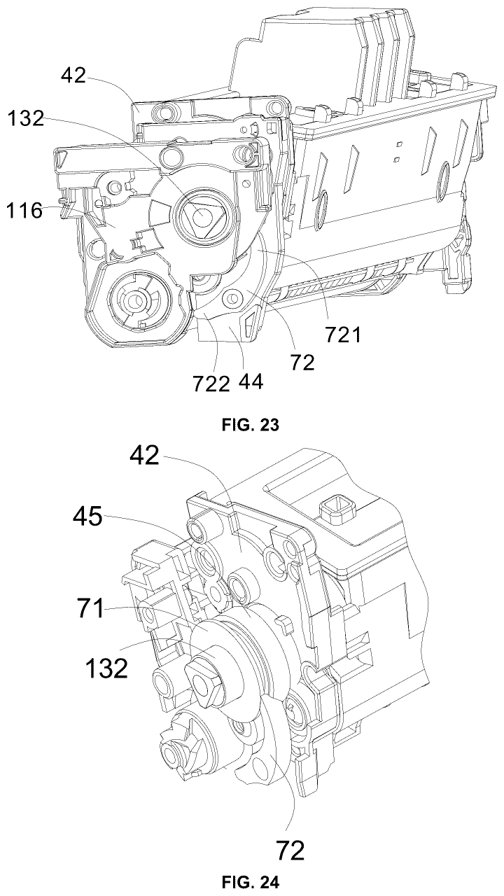

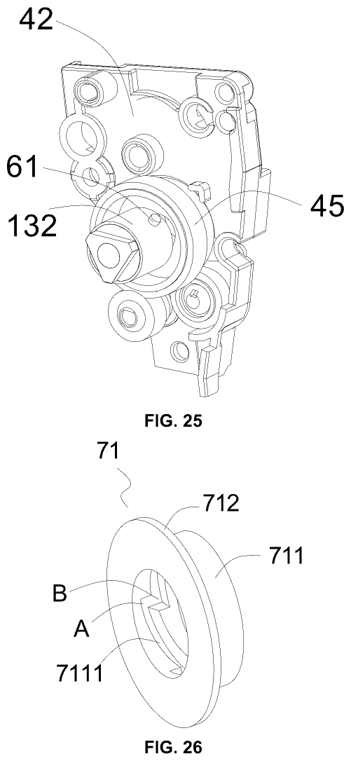

In the embodiment disclosed herein, the rotation direction is defined as a clockwise direction and a counterclockwise direction when looking from the driving side of the processing cartridge 100 toward the processing cartridge 100 (see the directions indicated in FIGS. 23-25).

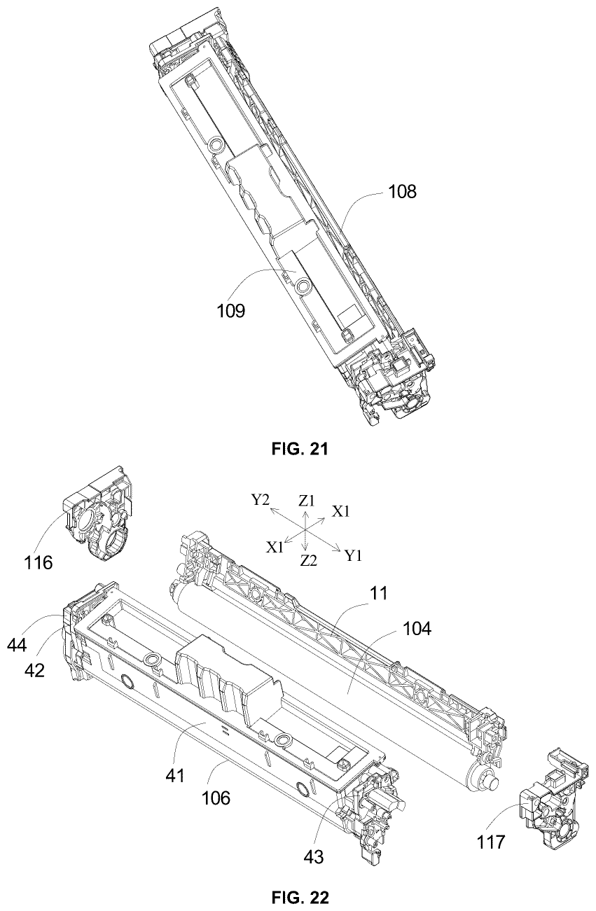

FIGS. 21-23 show a processing cartridge 100 according to Embodiment 2 of the present disclosure. The arrangement of the photosensitive unit of the processing cartridge 100 is basically the same as that of Embodiment 1. The developing unit, compared to Embodiment 1, further includes a driving side developing bracket 42 fixed to the driving side of the developing frame 41, a non-driving side developing bracket 43 fixed to the non-driving side of the developing frame 41, a sleeve 45 fixed to the driving side developing bracket 42 and sleeved on the outside of the developing coupling 132, and a developing protective cover 44 fixed to the outside of the driving side developing bracket 42. The developing coupling 132 is disposed on the driving side developing bracket 42. The driving side cover 116 covers the outside of the developing protective cover 44, and the non-driving side cover 117 covers the outside of the non-driving side developing bracket 43.

The photosensitive unit 108 and the developing unit 109 are connected by a spring or other non-fixed means, so that the developing unit 109 can rotate within a certain range relative to the photosensitive unit 108. Specifically, the developing unit 109 is configured to rotate between a contact position and a separated position relative to the photosensitive unit 108 with the rotation axis of the developing coupling 132 as the center, so that the photosensitive component 104 and the developing component 106 are in contact with or separated from each other.

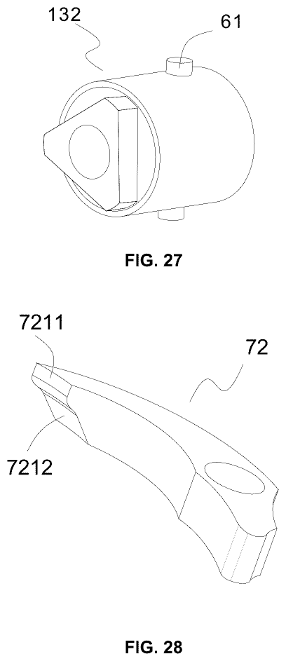

Referring to FIG. 27, the developing coupling 132 is provided with a first acting part 61 capable of interacting with the axial shifting component 71. The first acting part 61 is specifically formed as at least one protrusion on the outer circumferential surface of the developing coupling 132. The first acting part 61 and the developing coupling 132 can be integrally developed or separately manufactured and then fixedly connected. In the embodiment disclosed herein, the first acting part 61 is provided as two protrusions symmetrically distributed along the outer circumferential surface of the developing coupling 132.

In the embodiment disclosed herein, the clutch mechanism is disposed on the driving side of the processing cartridge 100, and includes an axial shifting component 71, a reset component (not shown in the figure), and a force-applying component 72.

The axial shifting component 71 is rotatably sleeved on the developing coupling 132, and can interact with the developing coupling 132, so that the axial shifting component 71 can move along the axial direction of the developing coupling 132. The reset component is configured to reset the axial shifting component 71 along the axial direction, and is disposed between the axial shifting component 71 and the developing unit 109. Preferably, the reset component is implemented as a second elastic component, such as a spring, one end of which abuts against the axial shifting component 71, and the other end abuts against the inner bottom surface of the sleeve 45. In some embodiments, other means other than the elastic component can also be configured to achieve the axial reset of the axial shifting component 71.

Referring to FIG. 26, in the embodiment disclosed herein, the axial shifting component 71 includes a hollow cylindrical portion 711 and a flange part 712 formed at the end of the hollow cylindrical portion 711 and having an enlarged outer diameter. The inner circumferential wall of the hollow cylindrical portion 711 is provided with a second acting part 7111 that cooperates with the first acting part 61 of the developing coupling 132, so that the axial shifting component 71 is moved in the axial direction through the action of the first acting part 61 and the second acting part 7111.

Specifically, the second acting part 7111 is in the shape of a plurality of circumferentially extending tapered chutes, the top end A of each tapered chute is inclined in the axial direction away from the processing cartridge 100, the bottom end B of each chute is inclined in the axial direction toward the processing cartridge 100, and the top end A of each chute is axially connected with the bottom end B of an adjacent tapered chute. The first acting part 61 of the developing coupling 132 is embedded in the second acting part 7111. When the developing coupling 132 receives the driving force and rotates clockwise, the first acting part 61 can move from the bottom end B of a tapered chute to the top end A thereof with the rotation of the developing coupling 132. Since the top end A and the bottom end B of the tapered chute have different axial positions, the axial relative position of the developing coupling 132 and the axial shifting component 71 changes. Since the axial direction of the developing coupling 132 is fixed, the axial shifting component 71 moves relative to the developing coupling 132 in the axial direction toward the processing cartridge 100 and remains in the retracted position. When the developing coupling 132 continues to rotate, due to the rotational force caused by the high-speed rotation, the first acting part 61 will generate a large friction force with the top surface of the top end A of the tapered chute, and the friction force is greater than the elastic force of the second elastic component. Therefore, under the action of the friction force, the first acting part 61 will not translate from the top end A of the tapered chute to the bottom end B of the adjacent tapered chute, but will remain at the top end A of the tapered chute, so that the axial shifting component 71 remains in the axial contraction position and rotates with the developing coupling 132. When the developing coupling 132 stops rotating, the friction force decreases, and under the action of the second elastic component, the first acting part 61 translates from the top end A of the tapered chute to the bottom end B of the adjacent tapered chute, so that the axial shifting component 71 moves axially and returns to the initial extended position.

The force-applying component 72 is disposed on the developing unit 109 and is configured to act with the axial shifting component 71. According to the axial position of the axial shifting component 71, the force-applying component 72 applies a thrust to the photosensitive unit 108 or averts the photosensitive unit 108, so that the developing unit 109 switches between the separated position and the contact position. In the embodiment disclosed herein, the force-applying component 72 is disposed on the developing protective cover 44, and the first end 721 of the force-applying component is configured to abut and interact with the axial shifting component 71, and the second end 722 of the force-applying component is configured to interact with the photosensitive unit 108 and apply a thrust thereto. In the embodiment disclosed herein, the force-applying component 72 is rotatably disposed on the developing protective cover 44 with the first direction as the rotation axis. When the force-applying component 72 rotates, it generates displacement in a direction perpendicular to the first direction. In some embodiments, the force-applying component 72 may also move in a translational motion, or other manners, instead of a rotational motion, as long as it can generate displacement in a direction perpendicular to the first direction, thereby applying a force to the photosensitive unit.

Referring to FIG. 28, the first end 721 of the force-applying component 72 is provided with a flat abutting surface 7211 and an inclined abutting surface 7212. When the axial shifting component 71 is in the extended position, the flange part 712 of the axial shifting component 71 abuts against the flat abutting surface 7211 of the force-applying component 72, so that the second end 722 of the force-applying component 72 abuts against the driving side cover 116 of the photosensitive unit 108 and applies a thrust force thereto, so that the developing unit 109 is subjected to a reaction force and rotates counterclockwise from the contact position to the separated position. When the axial shifting component 71 moves axially to the retracted position, the flange part 712 thereof is separated from the flat abutting surface 7211 and moves to the inclined abutting surface 7212 and abuts against the inclined surface. At this moment, the force-applying component 72 rotates counterclockwise, so that the second end 722 of the force-applying component 72 averts the photosensitive unit 108, and the developing unit 109 rotates clockwise from the separated position to the contact position due to the action of its own weight or the action of the rotational force torque.

When the processing cartridge 100 is mounted in the main assembly of the image forming device and the developing process has not started, the axial shifting component 71 is kept in the axially extended position, and its flange part 712 abuts against the flat abutting surface 7211 of the force-applying component 72. The second end 722 of the force-applying component 72 applies a thrust force to the driving side cover 116, and the developing unit 109 is maintained in the separated position by the reaction force. At this moment, the photosensitive component 104 and the developing component 106 are in a separated state.

When the processing cartridge 100 starts a developing process, the developing coupling 132 receives the driving force output by the main assembly to the developing unit and rotates, and interacts with the axial shifting component 71, so that the axial shifting component 71 moves to the retracted position in the axial direction toward the center of the processing cartridge 100, and then rotates together with the developing coupling 132. At the same time, the flange part 712 of the axial shifting component 71 abuts against the inclined abutting surface 7212 of the force-applying component 72. The force-applying component 72 rotates counterclockwise, so that the second end 722 of the force-applying component 72 averts the photosensitive unit 108. The developing unit 109 rotates clockwise from the separated position to the contact position due to the self-weight or the torque of the rotation force, so that the photosensitive component 104 contacts the developing component 106. It should be noted that in the above developing process, the inclined abutting surface 7212 of the first end 721 of the force-applying component 72 and the flange part 712 of the axial shifting component 71 are set to point contact or line contact, which will not interfere with the developing process.

When the developing process is finished, the driving force transmitted to the developing coupling 132 disappears, and the developing coupling 132 stops rotating. Under the action of the second elastic component, the axial shifting component 71 moves axially away from the center of the processing cartridge 100 to the initial extended position, and its flange part 712 moves from the inclined abutting surface 7212 of the force-applying component 72 to the flat abutting surface 7211 and abuts against it. The force-applying component 72 rotates clockwise, and its second end 722 applies a thrust force to the driving side cover 116. The developing unit 109 is rotated counterclockwise from the contact position to the separated position by the reaction force, so that the developing component 106 is separated from the photosensitive component 104. This solves the problem of long-term contact between the developing component 106 and the photosensitive component 104 when not in the developing process.

In some embodiments, the axial shifting component may not be disposed on the developing coupling 132, and may not be driven by the developing coupling 132, but may be disposed at other positions of the developing unit, as long as it can receive the driving force output by the main assembly to the developing unit. The shapes and structures of the first acting part and the second acting part may be different, for example, the first acting part may be a tapered chute extending in the circumferential direction, and the second acting part may be a protrusion, and the second acting part is embedded in the first acting part and can move in the first acting part.

### Embodiment 3

The main difference between Embodiment 3 and Embodiment 2 lies in that: the axial shifting component of the clutch mechanism converts the rotational motion into the axial motion in a different manner and structure, and the arrangement and structure of the force-applying component are different; the clutch mechanism of the embodiment disclosed herein further includes a rotating component, which is configured to be able to rotate using the driving force output by the main assembly to the developing unit; the axial shifting component has a rotating part, which is configured to convert the rotational motion of the rotating component into the axial movement of the axial shifting component.

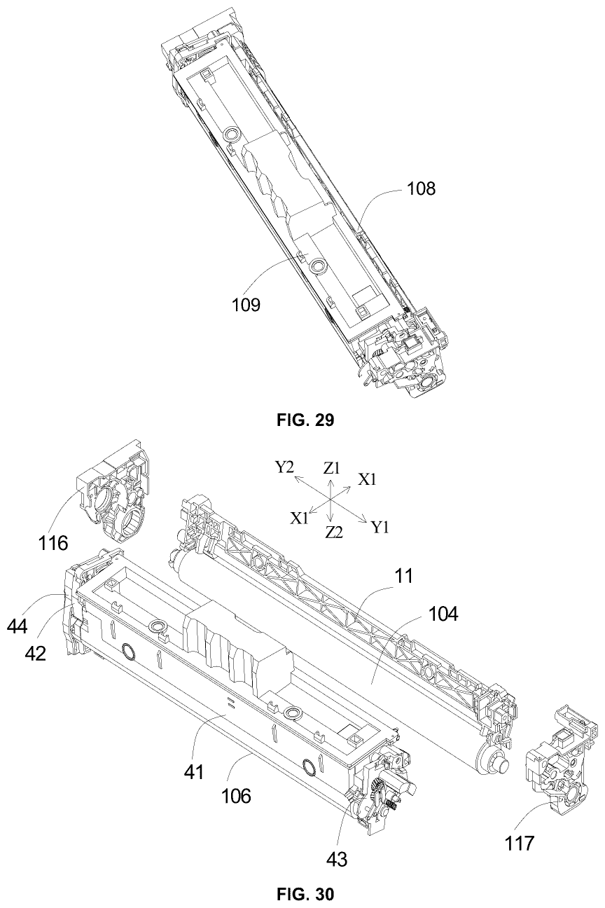

FIGS. 29-30 show a processing cartridge 100 according to Embodiment 3 of the present disclosure. The arrangement of the photosensitive unit and the developing unit of the processing cartridge 100 is substantially the same as that of Embodiment 2. The processing cartridge 100 may further include an elastic component 3, and the photosensitive unit 108 and the developing unit 109 may be connected by the elastic component 3 so that the developing unit 109 is in a separated position relative to the photosensitive unit 108 when the developing unit 109 is not subjected to the force of the force-applying component. Preferably, the elastic component 3 is a spring.

In the embodiment disclosed herein, the clutch mechanism includes a rotating component 81, an axial shifting component 82, a reset component and a force-applying component. The reset component can be a third elastic component 83, such as a spring. The rotating component 81, the axial shifting component 82, the third elastic component 83 and the force-applying component can be disposed on the driving side of the processing cartridge 100 or on the non-driving side of the processing cartridge 100. In the embodiment disclosed herein, these components are disposed on the non-driving side of the processing cartridge 100.

The developing unit 109 is configured to be rotatable between a contact position and a separated position relative to the photosensitive unit 108 around the rotation axis of the developing coupling 132, so that the photosensitive component 104 and the developing component 106 are in contact with or separated from each other.

The rotating component 81 is provided on the developing unit 109, and can receive the driving force from the developing drive coupling on the main assembly side and rotate. The rotating component 81 can be directly driven by the developing drive coupling on the main assembly side, or can be driven by other components driven by the driving force of the developing drive coupling on the main assembly side. In the embodiment disclosed herein, the rotating component 81 is fixed to the non-driving side of the stirring component, and is rotatably disposed on the non-driving side developing bracket 43, and receives the driving force of the developing drive coupling on the main assembly side through the stirring component.

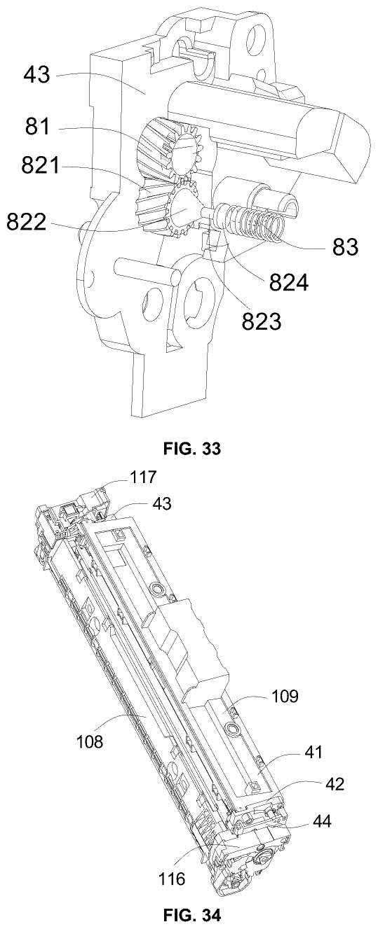

Referring to FIG. 33, the axial shifting component 82 is rotatably disposed on the developing unit 109, and includes a rotating part 821, an oblique abutting part 822, and a straight abutting part 823 connected in sequence. In the embodiment disclosed herein, preferably, the axial shifting component 82 is rotatably disposed on the non-driving side developing bracket 43, and the axial shifting component 82 also includes an end flange 824 disposed at the end of the straight abutting part 823. The end flange 824 is configured to abut against the third elastic component 83. The third elastic component 83 is connected between the photosensitive unit 108 and the axial shifting component 82, and is configured to reset the axial shifting component 82 in the axial direction. In the embodiment disclosed herein, the third elastic component 83 is a spring, which is disposed in the non-driving side cover 117, and the end flange 824 of the axial shifting component 82 is inserted into the non-driving side cover 117 and abuts against the third elastic component 83.

The rotating part 821 is configured to convert the rotational motion of the rotating component 81 into axial movement. In the embodiment disclosed herein, the rotating component 81 and the rotating part 821 are mutually meshing helical gears. When the rotating component 81 rotates, the axial force generated by the rotating part 821 will push the rotating part 821 to extend axially, so that the axial shifting component 82 compresses the third elastic component 83. During the operation of the processing cartridge 100, the rotating component 81 keeps rotating, and the axial shifting component 82 is simultaneously subjected to the axial thrust of the rotating component 81 and the elastic force of the third elastic component 83. At the beginning, the axial thrust is greater than the elastic force, and the axial shifting component 82 extends axially. The elastic force continues to increase until the two forces reach a balance and the axial shifting component 82 no longer moves. In the embodiment disclosed herein, the oblique abutting part 822 is a cone, and the straight abutting part 823 is a cylinder. The diameter of the straight abutting part 823 is equal to the minimum diameter of the oblique abutting part 822, so that the outer wall of the oblique abutting part 822 smoothly transitions to the straight abutting part 823. In some embodiments, the oblique abutting part 822 may also be in other shapes as long as it can abut against the force-applying component and push it to move, and the straight abutting part 823 may also be in other shapes as long as it can keep the force-applying component in a stationary state abutting against it.

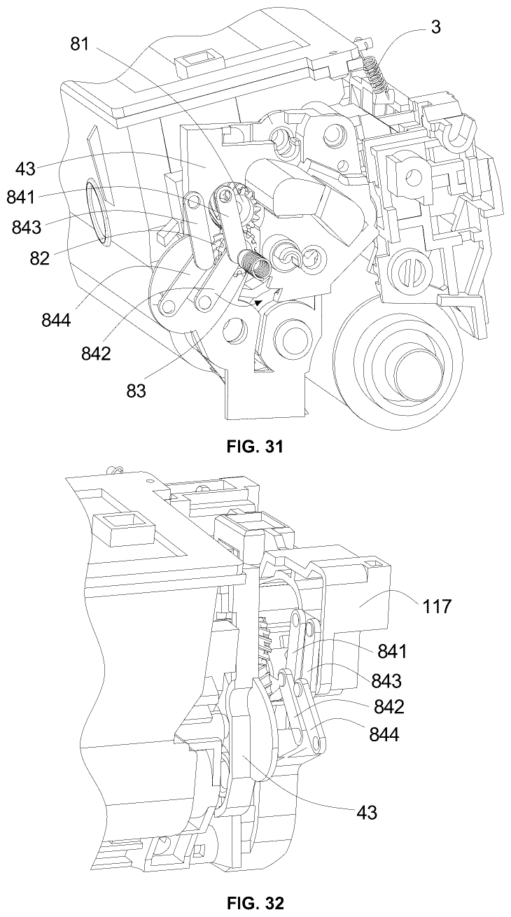

The force-applying component is connected between the developing unit 109 and the photosensitive unit 108, and the force-applying component abuts against the straight abutting part 823 or the oblique abutting part 822 of the axial shifting component 82, and applies a force to or withdraws a force from the developing unit 109, so that the developing unit 109 rotates between the contact position and the separated position. In the embodiment disclosed herein, the force-applying component includes a first linkage mechanism formed by a first connecting rod 841 and a second connecting rod 842 being hinged to each other. The first connecting rod 841 is hinged to the photosensitive unit 108, preferably, the non-driving side cover 117 (see FIG. 32). The second connecting rod 842 is hinged to the developing unit 109, preferably, the non-driving side developing bracket 43 (see FIG. 31). The angle formed by the first connecting rod 841 and the second connecting rod 842 is always less than 180 degrees. In some embodiments, the force-applying component can adopt other structures, as long as it can generate displacement in a direction perpendicular to the first direction, thereby applying a force to the photosensitive unit and/or the developing unit.

When the processing cartridge 100 is mounted in the main assembly of the image forming device and the developing process has not started, due to the action of the elastic component 3 between the developing unit 109 and the photosensitive unit 108, the developing unit 109 is in a separated position relative to the photosensitive unit 108. That is, the developing component 106 and the photosensitive component 104 are separated, and the connection point between the first connecting rod 841 and the second connecting rod 842 abuts against the straight abutting part 823 of the axial shifting component 82.

When the processing cartridge 100 starts a developing process, the processing cartridge 100 receives the driving force of the developing drive coupling on the main assembly side and drives the stirring component to start rotating. The stirring component drives the rotating component 81 to rotate, and the rotating part 821 of the axial shifting component 82 converts the rotational movement of the rotating component 81 into a movement in the axial direction away from the center of the processing cartridge 100, so that the connection point between the first connecting rod 841 and the second connecting rod 842 leaves the straight abutting part 823 of the axial shifting component 82 and abuts against the oblique abutting part 822. The oblique abutting part 822 pushes the first connecting rod 841 and the second connecting rod 842 to increase the angle between them, thereby causing the second connecting rod 842 to rotate counterclockwise (see the arrow in FIG. 31), applying a force to the developing unit 109, thereby causing the developing unit 109 to rotate from the separated position to the contact position. The developing component 106 then contacts the photosensitive component 104.

When the processing cartridge 100 shrinks toward the center to restore to the initial position, the connection point between the first connecting rod 841 and the second connecting rod 842 moves from the oblique abutting part 822 to the straight abutting part 823. The angle between the first connecting rod 841 and the second connecting rod 842 is reduced to the initial angle, and the force of the second connecting rod 842 on the developing unit 109 disappears, so that the developing unit 109 returns from the contact position to the separated position under the action of the elastic component 3. The developing component 106 and the photosensitive component 104 are separated, thereby averting the long-term contact between the developing component 106 and the photosensitive component 104 when not in a developing process. When the axial shifting component 82 shrinks in the axial direction, under the action of the rotating part 821, the rotating component 81 will rotate a certain angle.

In some embodiments, the opening angle of the first connecting rod 841 and the second connecting rod 842 is set in an opposite direction relative to the inclined direction of the oblique abutting part 822. When the connection point between the first connecting rod 841 and the second connecting rod 842 leaves the straight abutting part 823 of the axial shifting component 82 and abuts against the oblique abutting part 822, the oblique abutting part 822 pushes the first connecting rod 841 and the second connecting rod 842 to reduce their angle, thereby causing the second connecting rod 842 to rotate counterclockwise. Alternatively, the movement direction of the axial shifting component 82 is opposite, for example, the rotating part 821 of the axial shifting component 82 converts the rotational movement of the rotating component 81 into movement in the axial direction toward the center of the processing cartridge 100, and the movement direction or mode of other components is changed accordingly.

In some embodiments, the clutch mechanism further includes a second linkage mechanism formed by a third connecting rod 851 and a fourth connecting rod 852 being hinged to each other, the third connecting rod 851 being hinged to the photosensitive unit 108, preferably, the non-driving side cover 117, and the fourth connecting rod 852 being hinged to the developing unit 109, preferably, the non-driving side developing bracket 43. The angle formed by the third connecting rod 851 and the fourth connecting rod 852 is always less than 180 degrees. The second linkage mechanism is synchronized with the motion trajectory of the first linkage mechanism, and is configured to reinforce the supporting force or acting force on the developing unit 109.

### Embodiment 4

The main difference between Embodiment 4 and Embodiment 1 lies in that: in the embodiment disclosed herein, the switching of the developing unit and the photosensitive unit to the separated position is triggered by the photosensitive unit, and a first retaining part of the clutch mechanism and a second retaining part retain the developing unit and the photosensitive unit in the separated position; the switching of the developing unit and the photosensitive unit to the contact position is achieved by the disengagement of the first retaining part and the second retaining part.

The general configuration of Embodiment 4 is as follows.

The clutch mechanism includes a first retaining part, and the photosensitive unit 108 includes a second retaining part. The first retaining part can act with the second retaining part to keep the developing unit 109 and the photosensitive unit 108 in a separated position. When the main assembly outputs a driving force to the developing unit 109, the first retaining part disengages from the second retaining part, so that the developing unit 109 and the photosensitive unit 108 switch to a contact position.

The photosensitive unit 108 is configured such that when the main assembly stops outputting the driving force to the developing unit 109, the photosensitive unit 108 is configured to be able to use a driving force output by the main assembly to apply a force to the developing unit 109, so that the developing unit 109 and the photosensitive unit 108 are switched to a separated position. Further, the photosensitive unit 108 includes a first gear, and at least one side of the teeth of the first gear is configured as a non-driving side. The developing unit 109 includes a second gear, and the second gear can be linked with the driving force output by the main assembly to the developing unit 109. When the main assembly stops outputting the driving force to the developing unit 109, the second gear is stationary, and the first gear can rotate using the driving force output by the main assembly to the photosensitive unit 108, and apply a force to the second gear through the non-driving side, so that the developing unit 109 and the photosensitive unit 108 are switched to a separated position.

The specific configuration of Embodiment 4 is as follows.

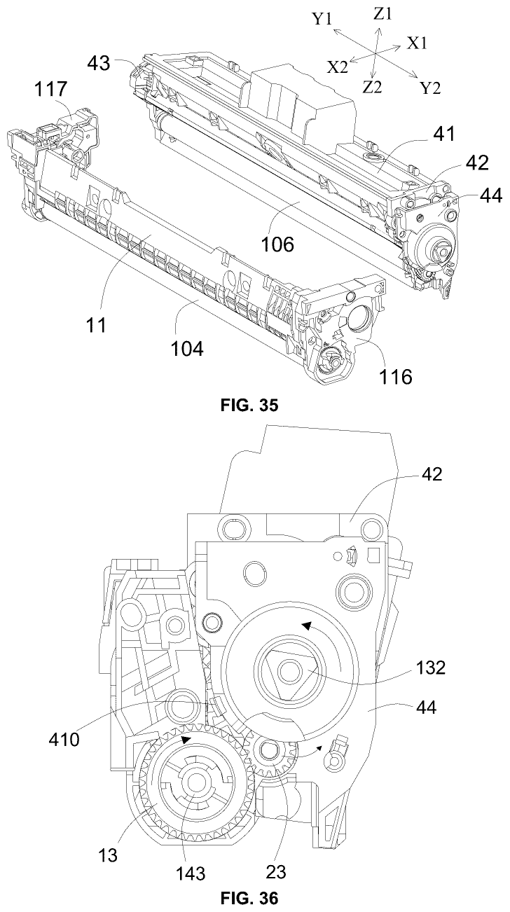

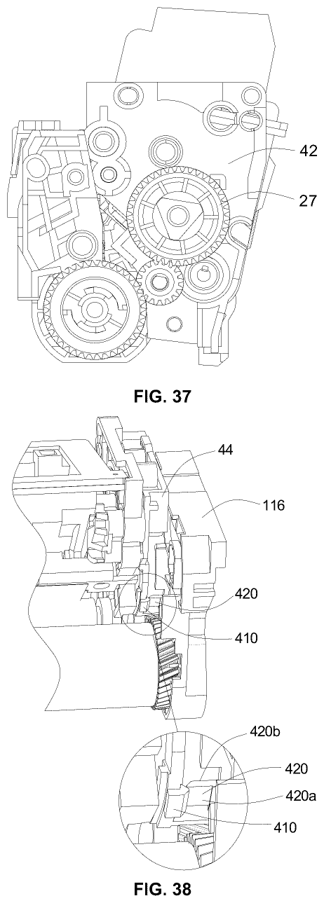

FIGS. 35-38 schematically show a processing cartridge 100 according to the present disclosure. The arrangement of the photosensitive unit and the developing unit of the processing cartridge 100 is substantially the same as that of Embodiment 2, except that the photosensitive unit of the embodiment disclosed herein further includes a first gear and a second retaining part 420. The first gear may be a photosensitive gear 13 fixedly disposed at the driving side of the photosensitive component 104, or may be disposed at other positions, as long as the first gear can receive the driving force output by the main assembly to the photosensitive unit for rotation.

The developing unit of the embodiment disclosed herein further includes a second gear and a driving gear 27. The second gear may be a developing gear 23 fixedly disposed at the driving side of the developing component 106, or may be disposed at other positions, as long as it can rotate when the main assembly outputs the driving force to the developing unit, and stop when the driving force stops outputting. The driving gear 27 is fixedly disposed in the developing coupling 132 and meshes with the developing gear 23. The developing coupling 132 extends outward through the developing protective cover 44 and the driving side cover 116, so as to be connected to the developing drive coupling on the main assembly side of the image forming device and receive the driving force.

The processing cartridge 100 adopts a dual drive method. When the processing cartridge is mounted in the main assembly of the image forming device, the developing coupling 132 is connected to the developing drive coupling on the main assembly side of the image forming device, receives its driving force, and then drives the stirring component, the powder feeding roller and the developing component 106 to rotate through the driving gear 27. The drum coupling 143 of the processing cartridge 100 is connected to the drum drive coupling on the main assembly side of the image forming device, and receives its driving force, thereby driving the photosensitive component 104 and the charging roller to rotate.

The developing unit 109 can rotate between a contact position and a separated position relative to the driving side cover 116 and the photosensitive unit 108 around the rotation axis of the developing coupling 132 so as to make the developing component 106 contact or separate from the photosensitive component 104.

When separated, the force driving the developing unit 109 to rotate relative to the photosensitive unit 108 comes from the force of the photosensitive gear 13 on the developing gear 23. The photosensitive gear 13 rotates as the drum coupling 143 receives the driving force of the drum drive coupling on the main assembly side of the image forming device, but its function is not to drive the developing gear 23 to rotate, but to push the developing unit 109 away by the force on the developing gear 23. At least one side of the teeth of the photosensitive gear 13 is set as a non-driving side, and the setting of the other side is not limited and can be a normal gear tooth surface. When the non-driving side acts on the stationary developing gear 23, it cannot play a driving role, but will produce a slipping effect, pushing the developing gear 23 away. The non-driving side can specifically be an inclined straight surface, or other shapes that can produce a slipping effect, thereby pushing the developing gear 23 away.

The clutch mechanism is configured to retain the developing unit 109 in the separated position until the developing coupling 132 receives the driving force of the main assembly, the retaining effect then fails, and the developing unit 109 returns to the contact position.

Referring to FIG. 38, in the embodiment disclosed herein, the clutch mechanism includes a first retaining part 410. The first retaining part 410 is disposed on the developing unit 109 to rotate with the developing unit 109. In some embodiments, the first retaining part 410 may be disposed on the developing protective cover 44 or on other components that can rotate with the developing unit 109.

The second retaining part 420 is disposed on the photosensitive unit, for example, can be disposed on the driving side cover 116, and does not rotate with the developing unit 109. In some embodiments, the second retaining part 420 can also be disposed on the photosensitive frame as long as it does not rotate with the developing unit 109.

The retaining part 410 is set to protrude from the developing protective cover 44 in the direction of the driving side cover 116, and the second retaining part 420 is set to protrude from the driving side cover 116 in the direction of the developing protective cover 44, so that the two can abut against each other and form a snap-fit effect under certain circumstances, and can also push each other apart and disengage under certain circumstances. In some embodiments, at least one side of one or both of the first retaining part 410 and the second retaining part 420 can be provided with an inclined surface so that the two can interact more smoothly. The inclined surface can be an inclined straight surface, an inclined arc surface or other shapes. In some embodiments, the first retaining part 410 and the second retaining part 420 can be set to other shapes as long as the two can contact and interact with each other.

When the processing cartridge 100 is mounted into the main assembly and the image forming device is in a preparation action, the drum coupling 143 receives the driving force of the image forming device, driving the photosensitive gear 13 to rotate. At the same time, the image forming device first outputs the driving force to the developing coupling 132 and then stops outputting the driving force to the developing coupling 132. When the driving force is stopped, the developing coupling 132, the driving gear 27 and the developing gear 23 are stationary. Due to the continuous rotation of the photosensitive gear 13, the non-driving side of its teeth will always contact the developing gear 23, but the developing gear 23 does not rotate, so it will be pushed away by the photosensitive gear 13. Since the developing gear 23 receives a thrust, the entire developing unit 109 is thus forcefully rotated in the counterclockwise direction (viewed from the driving side), and the developing unit rotates from the contact position to the separated position, thereby separating the photosensitive component 104 from the developing component 106. At the same time, the first retaining part 410 on the developing protective cover 44 abuts against the second retaining part 420 on the driving side cover 116 as the developing unit 109 rotates and slides relatively. The first retaining part 410 moves from the first side 420a of the second retaining part 420 to the second side 420b, and abuts against the second side 420b of the second retaining part 420, so that the developing unit 109 is retained at the separated position, keeping the separated state of the developing component and the photosensitive component. After the preparation action is completed, the drum drive coupling on the main assembly side of the image forming device stops outputting the driving force to the drum coupling 143 of the processing cartridge 100, and the drum coupling 143 stops rotating.

The drum coupling 143 and the developing coupling 132 of the processing cartridge 100 receive the driving force to rotate respectively, and the torque generated by the clockwise rotation of the developing coupling 132 causes the entire developing unit 109 to rotate clockwise. The first retaining part 410 rotates with the developing unit 109, pushing away the second retaining part 420. The first retaining part 410 moves from the second side of the second retaining part 420 to the first side, thereby disengaging from the second retaining part 420, so that the developing unit 109 returns from the separated position to the contact position, and the photosensitive component 104 contacts the developing component 106. At this moment, since the developing gear 23 receives the driving force output by the main assembly to the developing device to rotate, its rotation is synchronized with the rotation of the photosensitive gear 13, so the non-driving side of the teeth of the photosensitive gear 13 cannot push the developing gear 23 away.

When a color image needs to be printed, the four color processing cartridges 100 are all in a state where a developing component and a photosensitive component are in contact (i.e., the drum roller is in contact) to perform printing. When a black image is printed alone, merely the black processing cartridge 100 is in a state where the drum roller is in contact, and the other three color processing cartridges 100 are in a state where the drum roller is separated. That is, the developing unit 109 of a color processing cartridge 100 is kept in a separated position and the developing drive coupling on the main assembly side is not driven, while the photosensitive components 104 of the four color processing cartridges 100 are still driven by the drum coupling 143 to rotate, so that no large friction is generated with the transfer belt, so that the transfer belt can rotate smoothly.

The processing cartridge 100 of the embodiment disclosed herein does not need to be additionally provided with a protrusion to receive the separation force and contact force from the developing separation control unit of the main assembly. Instead, through the setting of the photosensitive gear 13, the developing unit 109 is pushed from the contact position to the separated position through its pushing action on the developing gear 23, thereby realizing the drum roller separation. The developing unit 109 is maintained in the separated position through the clutch mechanism. This design method is simple, omits the protrusion in the existing technology, simplifies the structure, is conducive to the miniaturization of the processing cartridge 100, and can also reduce production costs.

The foregoing are merely some embodiments of the present disclosure. For those skilled in the art, without departing from the creative concept of the present disclosure, several modifications and improvements can be made, or the above technical solutions can be freely combined, including the technical features between the above different embodiments, which all fall within the protection scope of the present disclosure.

What is claimed is:

1. A processing cartridge, comprising:
a photosensitive unit including a photosensitive component;
a developing unit including a developing component, wherein the developing unit is capable of moving between a contact position where the developing component contacts the photosensitive component and a separated position where the developing component is separated from the photosensitive component relative to the photosensitive unit;
a drum coupling for receiving a rotational driving force and transmitting the rotational driving force to the photosensitive component;
a developing coupling for receiving the rotational driving force and transmitting the rotational driving force to the developing component;
a force-applying component, wherein the force-applying component is capable of moving between an extended position where the developing component is separated from the photosensitive component and a retracted position where the developing component is in contact with the photosensitive component; and
an elastic member for moving the force-applying component from the retracted position to the extended position,
wherein, when the developing coupling does not receive the rotational driving force, the force-applying component is in the extended position under an action of the elastic member to separate the developing component from the photosensitive component, and when the developing coupling receives the rotational driving force to rotate the developing component, the force-applying component moves from the extended position to the retracted position, and the developing component is in contact with the photosensitive component.

2. The processing cartridge according to claim 1, wherein the processing cartridge has a driving side and a non-driving side, and the drum coupling, the developing coupling and the force-applying component are located on the driving side of the processing cartridge.

3. The processing cartridge according to claim 2, wherein:
when the photosensitive unit is set to be stationary, the developing unit is capable of rotating relative to the photosensitive unit around a rotation center; and
when viewed from the driving side of the processing cartridge, the force-applying component is located on the developing coupling or below the rotation center.

4. The processing cartridge according to claim 1, wherein, when the developing coupling does not receive a driving force to rotate the developing component, the force-applying component is in the extended position under the action of the elastic member and abuts against the photosensitive component or abuts against the photosensitive unit to separate the developing component from the photosensitive component.

5. The processing cartridge according to claim 4, wherein, when the developing coupling receives the driving force to rotate the developing component, the force-applying component moves from the extended position to the retracted position, an abutting force of the force-applying component disappears, and the developing component contacts the photosensitive component.

6. The processing cartridge according to claim 1, wherein:
the photosensitive unit and the developing unit are rotatably connected;
when the developing unit is subjected to the rotational driving force, the developing unit is capable of rotating in a clockwise direction relative to the photosensitive unit to contact the developing component with the photosensitive component; and
when the developing unit is not subjected to the rotational driving force, the developing unit rotates in a counterclockwise direction relative to the photosensitive unit, and the developing component and the photosensitive component are in a separated state.

7. A processing cartridge, comprising:
a photosensitive unit, including a photosensitive drum and a photosensitive frame;
a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum;
a developing coupling, configured for receiving a rotational driving force and arranged on a driving side of the developing unit; and
a force-applying component, rotatably arranged on the driving side of the developing unit, wherein the force-applying component is capable of applying a thrust force to or avoiding the photosensitive unit,
wherein, when the developing coupling does not receive the rotational driving force, the force-applying component maintains the developing unit in the separated position by applying the thrust force to the photosensitive unit, so that the photosensitive drum is separated from the developing roller, and when the developing coupling receives the rotational driving force and rotates, the developing unit rotates from the separated position to the contact position due to an action of a self-weight or a torque of the rotational driving force, so that the photosensitive drum is in contact with the developing roller.

8. The processing cartridge according to claim 7, further comprising an elastic member, wherein, when the developing coupling does not receive the rotational driving force, the force-applying member rotates clockwise under the action of the elastic member to apply the thrust force to the photosensitive unit to separate the photosensitive drum from the developing roller.

9. The processing cartridge according to claim 8, wherein:
a driving side cover is provided on a driving side of the photosensitive unit; and
when the developing coupling does not receive the rotational driving force, the force-applying member applies the thrust force to the driving side cover of the photosensitive unit to maintain the developing unit in the separated position by a reaction force.

10. The processing cartridge according to claim 9, wherein:
the developing unit further includes a developing protective cover;
the force-applying component is rotatably arranged on the developing protective cover; and
the driving side cover covers an outside of the developing protective cover.

11. The processing cartridge according to claim 9, wherein, when the developing coupling receives the rotational driving force to rotate, the force-applying component rotates counterclockwise to avoid the driving side cover of the photosensitive unit, and the developing frame rotates from the separated position to the contact position due to a self-weight or a torque of the rotational driving force.

12. The processing cartridge according to claim 8, wherein the force-applying component is located below the developing coupling when viewed from a driving side of the processing cartridge.

13. The processing cartridge according to claim 12, wherein:
the force-applying component includes a protruding end; and
when the developing coupling does not receive the rotational driving force, one end of the force-applying component applies the thrust force to the photosensitive unit to maintain the developing unit in the separation position.

14. The processing cartridge according to claim 7, wherein the photosensitive unit and the developing unit are connected by a spring so that the developing unit rotates relative to the photosensitive unit within a certain range.

15. A processing cartridge, comprising:
a photosensitive unit, including a photosensitive drum and a photosensitive frame;
a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum;
a developing coupling, configured for receiving a rotational driving force and arranged on the driving side of the developing unit; and
an elastic component, connecting the photosensitive unit and the developing unit,
wherein, when the developing coupling does not receive a rotational driving force, the developing unit returns from the contact position to the separated position under an action of the elastic component, so that the developing roller is separated from the photosensitive drum, and when the developing coupling receives the rotational driving force to rotate, the developing unit rotates from the separated position to the contact position, so that the developing roller is in contact with the photosensitive drum.

16. The processing cartridge according to claim 15, wherein the elastic component is arranged on one side of an axial direction of the processing cartridge, one end of the elastic component is connected to the photosensitive unit, and another end of the elastic component is connected to the developing unit.

17. The processing cartridge according to claim 15, wherein:
the photosensitive unit further includes a driving side cover, and the developing unit further includes a driving side developing bracket; and
the developing coupling is arranged on the driving side developing bracket, and the driving side cover is arranged on an outside of the driving side developing bracket.

18. A processing cartridge, comprising:
a photosensitive unit, including a photosensitive drum and a photosensitive frame;
a developing unit, including a developing roller and a developing frame, wherein the developing unit is capable of rotating relative to the photosensitive unit between a contact position where the developing roller contacts the photosensitive drum and a separated position where the developing roller is separated from the photosensitive drum;
a drum coupling, configured for receiving a rotational driving force and transmitting the rotational driving force to the photosensitive drum;
a developing coupling, for receiving the rotational driving force and transmitting the rotational driving force to the developing roller; and
a clutch mechanism, arranged on the photosensitive unit or on the developing unit,
wherein, before the developing coupling receives the rotational driving force, the clutch mechanism keeps the developing unit in the separation position, and the developing roller is separated from the photosensitive drum, and when the developing coupling receives the rotational driving force and rotates, a torque generated by a rotation of the developing coupling causes the developing unit to rotate clockwise, so that the developing unit rotates from the separated position to the contact position, and the developing roller contacts the photosensitive drum.

19. The processing cartridge according to claim 18, wherein the clutch mechanism includes a first retaining part, which is arranged on the developing unit to rotate with a rotation of the developing unit.

20. The processing cartridge according to claim 18, wherein:
a driving side of the photosensitive unit is provided with a driving side cover, and the drum coupling extends outward through the driving side cover; and
a driving side of the developing unit is provided with a developing protective cover, the first retaining part is arranged on the developing protective cover, and a shape of the first retaining part is set to protrude from the developing protective cover to the driving side cover.

21. The processing cartridge according to claim 20, wherein:
the clutch mechanism further includes a second retaining part, which is arranged on the driving side cover; and
one side of the first retaining part or the second retaining part is provided with an inclined surface.
